(19) United States
(12) Patent Application Publication
(10) Pub. No.: US 2009/0246360 A1
(43) Pub. Date: Oct. 1, 2009

(54) OXIDE SOURCE MATERIAL SOLUTION, OXIDE FILM, PIEZOELECTRIC ELEMENT, METHOD FOR FORMING OXIDE FILM AND METHOD FOR MANUFACTURING PIEZOELECYTRIC ELEMENT

(75) Inventors: Yasuaki HAMADA, Suwa (JP); Takeshi KIJIMA, Saitama (JP)

Correspondence Address: HARNESS, DICKEY & PIERCE, P.L.C., P.O. BOX 828, BLOOMFIELD HILLS, MI, 48303, US

(73) Assignee: Seiko Epson Corporation, Tokyo (JP)

(21) Appl. No.: 12/413,880

(22) Filed: Mar. 30, 2009

(30) Foreign Application Priority Data
Apr. 1, 2008 (JP) 2008-095044

(51) Int. Cl. B05D 3/02; C04B 35/499

(52) U.S. Cl. 427/100; 252/62.9 PZ

(57) ABSTRACT

An oxide source material solution for forming an oxide film having a composition expressed by PbᵤZrₓTi_{1-x-y}M_{y}O₃ is presented. A composition of metal element constituents in the oxide source material solution is expressed by [Pb]:([Zr]+[Ti]+[M])=v:1, and a difference (v−u) in composition ratio of Pb between the oxide source material solution and the oxide film is 0.01 or less.

This application claims a priority to Japanese Patent Application No. 2008-095044 filed on Apr. 1, 2008 which is hereby expressly incorporated by reference herein in its entirety.

### BACKGROUND

1. Technical Field

The present invention relates to oxide source material solution that is used for piezoelectric elements, and oxide films formed by sintering the same.

2. Related Art

Piezoelectric elements are elements that use the phenomenon in which crystals are charged when deformed, or deformed when placed in an electric filed, and are used for liquid jet apparatuses such as ink jet printers.

Piezoelectric thin films such as PZT (lead titanate zirconate: Pb(ZrₓTi₁₋ₓ)O₃) films are used for such piezoelectric elements.

For example, Japanese Laid-open Patent Applications JP-A-2005-100660 (Patent Document 1) describes ferroelectric films formed from an oxide that is generally expressed by a general formula AB₁₋ₓNbₓO₃, where the element A is composed of at least Pb, the element B is composed of at least one or more of Zr, Ti, V, W and Hf, and include Nb in the range of 0.05≦x≦1.

The inventors named in the present application have been conducting researches and developments on ferroelectric elements and piezoelectric elements, and examining the improvement of characteristics of oxide films (ferroelectric films, piezoelectric films) used for these elements. For example, the inventors proposed, in the Patent Document 1, adding Nb (niobate) in PZT films to improve the film characteristics.

More specifically, the inventors discovered that the characteristics of a PZT film would be improved by replacing a part of Ti or Zr in the PZT film with Nb, and made the proposal.

However, as the inventors advanced further research and development, there were cases where differences in the crystal orientation were observed among the aforementioned PZTN films. In particular, when the steps of coating source material solution for a PZTN film and sintering the film were repeated to form a thick film, it was found that the orientation of the lower layer portion and that of the upper layer portion were different, and the film characteristics deteriorated.

### SUMMARY

In accordance with an advantage of some aspects of the invention, oxide source material solutions and oxide films with excellent characteristics can be provided. Also, in accordance with another advantage of some aspects of the invention, the characteristics of piezoelectric elements can be improved by using the aforementioned oxide source material solutions and oxide films.

(1) An oxide source material solution in accordance with an embodiment of the invention pertains to a source material solution for forming an oxide film having a composition expressed by PbᵤZrₓTi_{1-x-y}M_{y}O₃, wherein a composition of metal element constituents in the source material solution is expressed by [Pb]:([Zr]+[Ti]+[M])=v:1, and a difference (v−u) in composition ratio of Pb between the source material solution and the oxide film is 0.01 or less. M is a metal element.

In accordance with an aspect of the embodiment, the value v may be 0.95 or higher but 1.15 or lower. Also, the element M may be one of or both of Ta and Nb. Also, the value y may be in the range of 0.05≦y<0.2.

By adjusting the oxide source material solution in this manner, the crystal orientation of an oxide film formed by sintering the solution can be improved.

The oxide source material solution may contain 0.05 mol or less of Si or Ge as an additive for 1 mol of PbZrₓTi_{1-y}M_{y}O₃. By such composition, the characteristics of the oxide film can be further improved.

(2) An oxide film in accordance with an embodiment of the invention is formed by sintering the oxide source material solution described above. According to such composition, the crystal orientation of the oxide film can be improved. The aforementioned PbᵤZrₓTi_{1-x-y}M_{y}O₃ has an ABO₃ type perovskite structure.

(3) A piezoelectric element in accordance with an embodiment of the invention has the oxide film as a piezoelectric film. According to such composition, the characteristics of the piezoelectric element can be improved.

(4) A method for forming an oxide film in accordance with an embodiment of the invention includes the steps of: preparing a source material solution for forming an oxide film having a composition expressed by PbZrₓTi_{1-x-y}M_{y}O₃, wherein a composition of metal element constituents in the source material solution is expressed by [Pb]:([Zr]+[Ti]+[M])=v:1; adjusting the value v such that a difference (v−u) in composition ratio of Pb between the source material solution and the oxide film is 0.01 or less; and coating and then sintering the source material solution to form the oxide film. The value v may be 0.95 or higher but 1.15 or lower. The element M may be one of or both of Ta and Nb. Also, the value y may be in the range of 0.05≦y<0.2. According to the method, the crystal orientation of the oxide film can be improved.

In accordance with an aspect of the embodiment, the steps of coating and sintering are repeated a plurality of times. Even when repeating the steps of coating and sintering a plurality of times, an oxide film with excellent crystal orientation can be formed.

A method for manufacturing a piezoelectric element in accordance with an embodiment of the invention includes the method for forming an oxide film described above as a method for forming a piezoelectric film. According to this method, a piezoelectric element with excellent characteristics can be manufactured.

### BRIEF DESCRIPTION OF THE DRAWINGS

FIG. 1 is a perspective view showing a crystal structure of PZT.

FIGS. 2A-2C shows steps of a method for forming a PZTN film in accordance with an embodiment of the invention.

FIG. 3 is a table showing compositions of PZTN films formed with source material solutions (No. 1-No. 4).

FIGS. 4A-4D are graphs showing X-ray diffraction analysis results of the PZTN films No. 1-No. 4, respectively.

FIG. 5 is a table showing compositions of PZTN films formed with source material solutions (Nos. 3, 5 and 6).

FIGS. 6A-6B are graphs showing X-ray diffraction results of the PZTN films No. 5 and No. 6, respectively.

FIG. 7 is a graph showing crystal orientations of films with respect to different compositions of source material solutions in the source material solutions Nos. 1-4, respectively.

FIGS. 8A-8C are cross-sectional views showing steps of a method for manufacturing an ink jet recording head (liquid jet head) having a piezoelectric element in accordance with an embodiment of the invention.

FIGS. 9A-9C are cross-sectional views showing steps of the method for manufacturing an ink jet recording head (liquid jet head) having a piezoelectric element in accordance with the embodiment of the invention.

FIGS. 10A-10C are cross-sectional views showing steps of the method for manufacturing an ink jet recording head (liquid jet head) having a piezoelectric element in accordance with the embodiment of the invention.

FIGS. 11A-11B are cross-sectional views showing steps of the method for manufacturing an ink jet recording head (liquid jet head) having a piezoelectric element in accordance with the embodiment of the invention.

FIG. 12 is an exploded perspective view of an ink jet recording head.

FIG. 13 is a schematic perspective view of a main part of an ink jet printer apparatus (a liquid jet apparatus).

### DESCRIPTION OF EXEMPLARY EMBODIMENTS

Preferred embodiments of the invention are described in detail below with reference to the accompanying drawings. It is noted that components having the same function shall be appended with the same or relating reference numbers and their description shall not be repeated.

Structure of PZTN Film

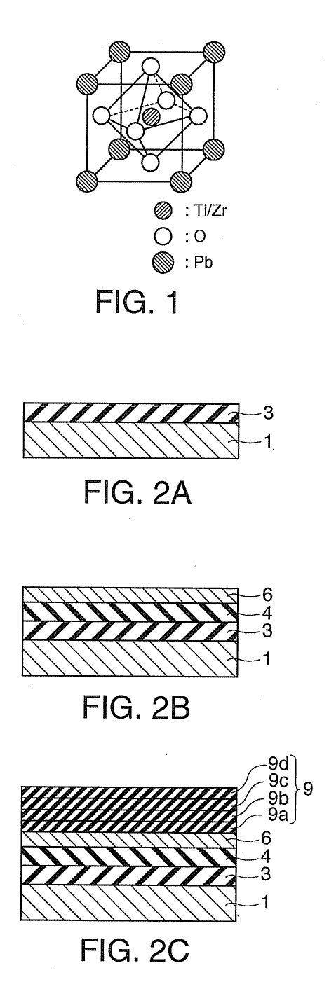

FIG. 1 is a diagram showing the structure of a PZT film. The PZT (Pb (ZrₓTi₁₋ₓ)O₃) film has a perovskite structure, having a cubic system unit lattice in which Pb atoms sit at cube corner positions, oxygen (O) atoms sit at face centered positions, and Ti or Zr atom sits at body center position. x is in the range of 0<x<1.

A PZTN film has a structure in which a portion of Ti or Zr at body center position is replaced with Nb, and its composition may be expressed by PbᵤZrₓTi_{1-x-y}M_{y}O₃.

Method for Forming PZTN Film

Next, a piezoelectric element using the PZTN film and its manufacturing method shall be described. FIGS. 2A-2C are cross-sectional views showing steps of a method for forming a PZTN film in accordance with an embodiment of the invention.

First, as shown in FIG. 2A, as a substrate 1, for example, a silicon (Si) substrate is prepared, and an elastic film (vibration plate) 3, such as, a silicon oxide film is formed on the surface of the substrate 1. The silicon oxide film may be formed by, for example, thermal oxidation to a film thickness of about 400 nm.

Then, as shown in FIG. 2B, on the elastic film 3, a dielectric film 4 composed of titanium oxide is formed. More specifically, a titanium (Ti) film is formed on the elastic film 3 by, for example, a DC sputter method to a film thickness of about 20 nm, and the film is heat-treated, for example, at 600° C. for 30 minutes, thereby forming the dielectric film 4 composed of titanium oxide having a film thickness of about 40 nm.

Next, a lower electrode film 6 composed of a conductive film, such as, for example, a platinum (Pt) film is formed on the dielectric film 4. The Pt film may be deposited by, for example, a DC sputter method to a thickness of about 150 nm.

Then, as shown in FIG. 2C, a PZTN film 9 is formed on the lower electrode film 6 as a piezoelectric film (a dielectric body, a piezoelectric layer). The PZTN film 9 may be formed through coating a solution (source material solution) in which organometallic compounds containing Pb, Zr, Ti and Nb, respectively, are dissolved in a solvent on the substrate by an appropriate coating method, such as, a spin coat method, and then heat-treating (drying, cleaning and sintering) the coated film.

As the organometallic compound containing Pb, lead acetate, lead octoate, lead oleate, lead cyclohexane butyrate, lead stearate, lead thiocyanate, lead naphthenate, lead maleate, lead di-i-propoxy, and lead bis (dipivaloylmethanate) may be used. As the organometallic compound containing Zr, zirconium acetylacetonato, tetramethoxy zirconium, tetraethoxy zirconium, tetra-i-propoxy zirconium, tetra-n-propoxy zirconium, tetra-i-butoxy zirconium, tetra-n-butoxy zirconium, tetra-sec-butoxy zirconium, tetra-t-butoxy zirconium, zirconium octylate, (isopropoxy)tris(dipivaloylmethanate)zirconium, tetrakis(dipivaloylmethanate)zirconium, tetrakis(ethylmethylamino)zirconium, and bis(cyclopentadienyl)dimethyl-zirconium may be used. As the organometallic compound containing Ti, titanium diisopropoxide bis(2,4-pentandionate), titanil acetylacetonate, tetramethoxy titanium, tetraethoxy titanium, tetra-i-propoxy titanium, tetra-n-propoxy titanium, tetra-n-butoxy titanium, tetra-i-butoxy titanium, tetra-sec-butoxy titanium, tetra-t-butoxy titanium, titanium octoate, tetrakis(dimethylamino)titanium, tetrakis diethylamino titanium, and di(isopropoxy)bis(dipivaloylmethanate) titanium may be used. As the organometallic compound containing Nb, penta-methoxy niobium, penta-ethoxy niobium, penta-i-propoxy niobium, pentane propoxy niobium, penta-i-butoxy niobium, penta-n-butoxy niobium, penta-sec-butoxy niobium, and niobium octoate may be used. As the solvent, for example, i-propanol, n-butanol, n-octanol, ethylene glycol, and propylene glycol may be used.

For example, the source material solution of Pb (Zr, Ti, Nb) O₃ adjusted to have a concentration of 0.29 mol/L (litter) is coated on a Pt film by a spin coat method at 1500 rmp, thereby forming a precursor film. Then, the film is heat-treated at 300° C. for three minutes, thereby drying and cleaning the film. The cleaning is conducted to thermally decompose organic compositions remaining in the PZTN precursor film after the drying step into NO₂, CO₂, H₂O and the like, and to remove them. The coating, drying and cleaning steps are repeated three times, and then sintering (heat treatment) is conducted at 750° C. for one minute by using a lamp anneal furnace, thereby forming a first PZTN film 9a.

Then, the steps from coating to sintering in the first round described above are repeated three times to form second-fourth PZTN films (9b, 9c and 9c), and then sintering is conducted at 750° C. for ten minutes by using a lamp anneal furnace, thereby forming a PZTN film 9 having a film thickness of about 700 nm.

### EMBODIMENT EXAMPLE 1

Source material solutions (No. 1-No. 4) in which the molar concentration of Pb [Pb] was adjusted in the range of 0.989-1.211 times the sum of the molar concentration of Zr, Ti and Nb ([Zr]+[Ti]+[M]) being 1 in the source material solutions were prepared, and PZTN films were formed in the condition described above. Film characteristics of the PZTN films are described below.

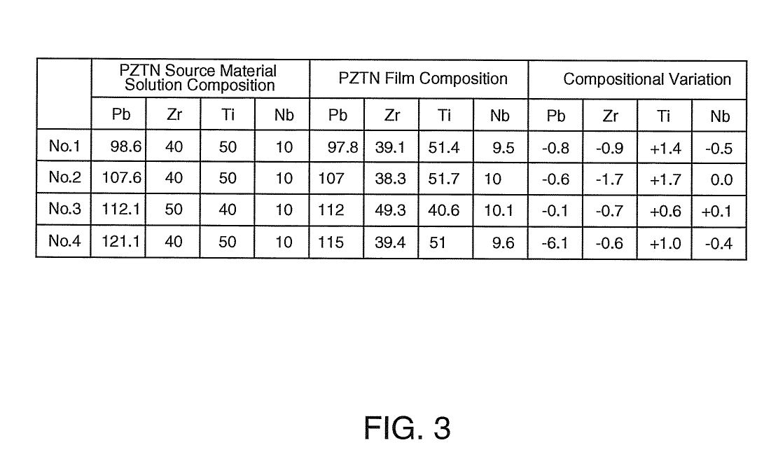

FIG. 3 is a table showing compositions of the PZTN films formed with the source material solutions (No. 1-No. 4), respectively. The compositions of the PZTN films after sintering were obtained by IPC (inductively coupled plasma) spectrometry.

It is noted that, in the table in FIG. 3, “PZTN Source Material Solution Composition” indicates rates [%] of the molar concentrations of the elements (Pb, Zr, Ti and Nb) in the source material solutions, respectively. For example, the value of [Pb] indicates a rate [%] of its molar concentration with respect of that of ([Zr]+[Ti]+[M]) being 100%.

In the table in FIG. 3, “PZTN film composition” indicates rates [%] of the compositions of the elements of the PZTN films obtained after sintering the source material solution, respectively. For example, the value of [Pb] indicates its rate [%] with respect of that of ([Zr]+[Ti]+[M]) being 100%.

In the table in FIG. 3, “Compositional Variation” indicates a value for each element obtained by subtracting its PZTN source material solution composition from its PZTN film composition.

As shown in FIG. 3, the rates [%] of Zr, Ti and Nb in each of the source material solutions were 40, 50 and 10, respectively. In this case, the source material solutions whose rate [%] of Pb was set to 98.6, 107.6 and 121.1 correspond to the source material solutions No. 1, No. 2 and No. 4, respectively. It is noted that, in the source material solution No. 3, the rates [%] of Zr, Ti and Nb were 50, 40 and 10, respectively, and the rate [%] of Pb was set to 112.1.

The compositional variation [%] in Pb in the source material solutions No. 1-No. 3 were −0.8, −0.6 and −0.1, respectively, which were relatively small. The compositional variation [%] in Pb in the source material solution No. 4 was −6.1.

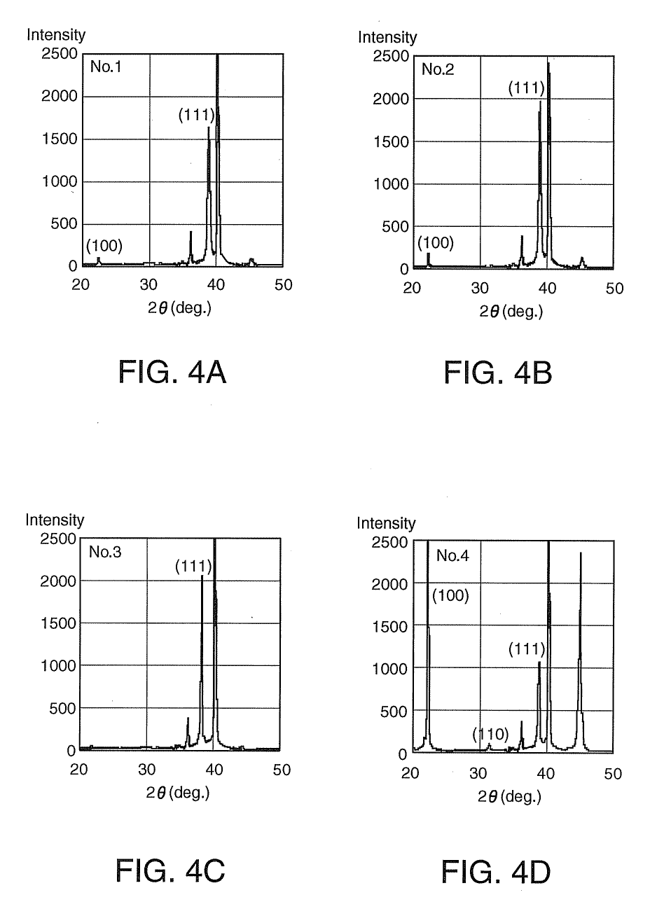

Also, FIGS. 4A-4D are graphs showing X-ray diffraction results of the PZTN films No. 1-No. 4. 2θ (deg.) is plotted along the axis of abscissas and the intensity of X-ray is plotted along the axis of ordinates. θ is an angle (θ) defined between the X ray and a plane, according to Bragg's law (2d sin θ=nλ). d is the spacing between planes formed by atoms (atomic netplanes) in the crystal which cause X-ray diffraction, n is any integer, and λ is the wavelength of the X-ray. For example, when Cu is used as a target, the (100) peak was present at 2θ=22−23°, the (110) peak was present at 2θ=31−32°, and the (111) peak was present near 2θ=39°. As shown in FIGS. 4A-4C, in other words, with the source material solutions No. 1-No. 3, highly oriented PZTN films preferentially oriented to (111) were obtained. However, as shown in FIG. 4D, in other words, with the source material solution No. 4, a PZTN film with mixed orientations mainly oriented to (100) and (111) was obtained.

### EMBODIMENT EXAMPLE 2

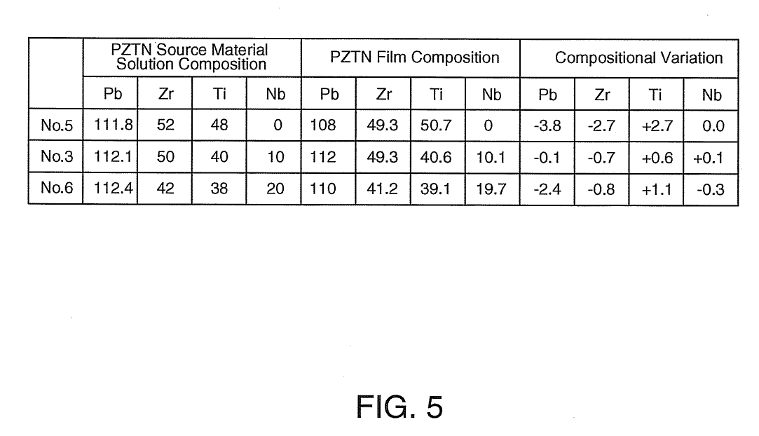

FIG. 5 is a table showing compositions of the PZTN films formed with the source material solutions (No. 3, No. 5 and No. 6), respectively.

As shown in FIG. 5, when the rates [%] of Zr, Ti and Nb in the source material solution were set at 42, 38 and 20, respectively, and the rate [%] of Pb was set to 112.4 (No. 6), the compositional variation in Pb was −2.4. When the rate [%] of Nb was 0, in other words, in the case of a PZT film (No. 5), and the rate [%] of Pb was 111.8, the compositional variation in Pb was −3.8. When the rates [%] of Zr, Ti and Nb in the source material solution were set at 50, 40 and 10, respectively, and the rate [%] of Pb was set to 112.1 (No. 3), the compositional variation in Pb was −0.1.

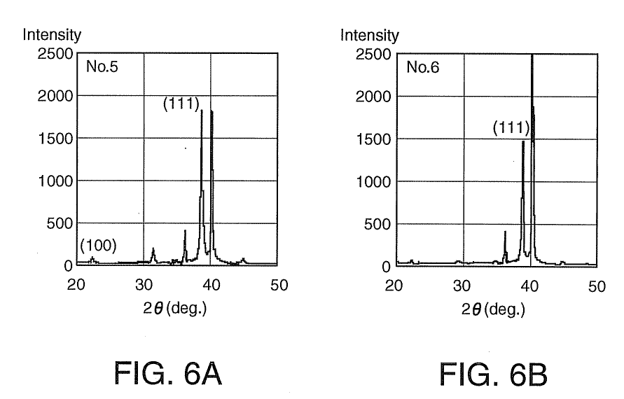

FIGS. 6A and 6B are graphs showing X-ray diffraction results of the PZTN films No. 5 and No. 6.

As shown in FIGS. 6A and 6B and FIG. 4C, with the source material solutions Nos. 3, 5 and 6, highly oriented PZTN films preferentially oriented to (111) were obtained. However, the sample No. 3 resulted in a highest degree of (111) orientation, and the sample No. 6 (FIG. 6B) resulted in a small diffraction peak caused by heterogeneous phases near 2θ=29°.

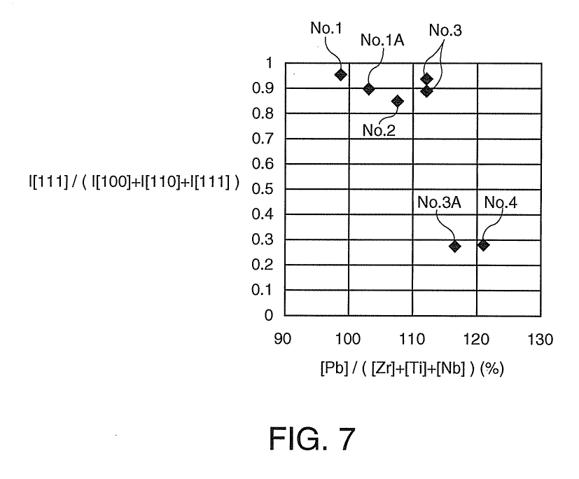

FIG. 7 is a graph showing crystal orientations for compositions of source material solutions in source material solutions Nos. 1-4, respectively, according to the embodiment examples 1 and 2. Values of [Pb]/([Zr]+[Ti]+[M]) of the source material solutions are shown along the axis of abscesses, and rates of (111) orientation (I(111)/(I(100)+I(110)+I(111)) in the PZTN films are shown along the axis of ordinates. Two dots corresponding to the two samples No. 3 according to the embodiment examples 1 and 2 are plotted in the graph. Also, the graph shows a dot plotted for the rate of (111) orientation obtained when the rates [%] of Zr, Ti and Nb in the source material solution were set to 40, 50 and 10, respectively, and the rate [%] of Pb was set to 103.1 (No. 1A), and a dot plotted for the rate of (111) orientation obtained when the rates [%] of Zr, Ti and Nb in the source material solution were set to 40, 50 and 10, respectively, and the rate [%] of Pb was set to 116.6 (No. 3A).

Consideration

The following aspects can be observed from the embodiment examples 1 and 2, and from FIG. 7. The samples No. 1-No. 3 with the compositional variation [%] in Pb being 1% (0.01) or lower had excellent orientation property. Therefore, when a source material solution for forming an oxide film has a composition expressed by PbᵤZrₓTi_{1-x-y}M_{y}O₃, and a composition of metal element constituents in the source material solution is expressed by [Pb]:([Zr]+[Ti]+[M])=v:1, it became clear that the crystal orientation characteristic becomes favorable when a difference (v−u) in composition ratio of Pb between the source material solution and the oxide film is 0.01 or less. It is considered that a more preferable range of the difference (v−u) is between 0 and 0.003. The value u of PZTN films in the range between 0.95 and 1.15 may be preferable, and the range between 1.08 and 1.15 may be more preferable. Therefore, by adjusting the value v to achieve the ranges described above, excellent PZTN films can be obtained.

Also, as shown in FIG. 7, when the composition of Pb in the source material solution is 95% or higher but 115% or lower (in the case of the samples No. 1-No. 3 and No. 1A), their orientation characteristic was favorable. Therefore, it became clear that, in addition to the condition of (v−u) being 0.01 or lower, when the value v is 0.95 or higher but 1.15 or lower, the orientation characteristic is favorable.

In this manner, by approximating Pb composition in PZTN films to be formed to Pb composition in the source material solution, the crystal orientation of the formed films can be improved.

Also, when the composition of Nb in films is less than 19.7% (see the sample No. 6), it was found that favorable film characteristics could be obtained.

The effectiveness of the addition of Nb is considered as follows. Nb may also have a valence of +4, such that it can function as a substitute for Ti⁴⁺, and Nb has a size that is generally the same as that of Ti (ionic radii are close to each other and atomic radii are identical), and weighs twice as much as that of Ti. Therefore, it is hard for atoms to slip out the lattice even by collision among atoms by lattice vibration. Further, its valence is +5, which is stable. Therefore, even when Pb slips out of the lattice, the valence resulting from the vacated Pb can be supplemented by Nb⁵⁺, such that the crystallinity can be stabilized. Also, even if Pb vacancy occurs at the time of crystallization, it is easier for Nb having a smaller size to enter than 0 having a larger size to slip out, for stabilizing the crystallinity. Therefore, the Pb vacancy can be supplemented by the addition of Nb, whereby the crystal stability can be achieved. Moreover, Nb has a very strong covalent bond, and it is believed that Pb is also difficult to slip out due to the addition of Nb (see, for example, H. Miyazawa, E. Natori, S. Miyashita; Jpn. J. Appl. Phys. 39 (2000) 5679).

In order to exhibit the effect of Nb addition, it is said that the addition of 5% (0.05) or more is desirable (See Japanese Laid-open Patent Application JP-A-2005-100660). Therefore, it is believed that, when the Nb film composition is 5% or greater but less than 20%, in other words, when the above-mentioned value y is in the range of 0.05≦y<0.2, the orientation characteristic becomes favorable.

Moreover, by adding Si compound (for example, PbSiO₃ silicate) in the source material solution by, for example, 1-5 mol % for one mol of PZTN film, the crystallization energy of the PZTN film can be reduced. In other words, by adding Si compound in addition to Nb, the crystallization temperature of PZTN can be reduced. Similar effects can be obtained by using Ge compounds instead of Si compounds.

It is noted that the embodiments have been described using films having (111) orientation as an example, but the invention is not limited to the embodiments described above. The orientation plane changes according to the orientation of a lower layer (in this case, Pt). Therefore, by changing the orientation of a lower layer, films in a variety of orientations can be formed.

Method for Manufacturing Piezoelectric Element Using PZTN Films

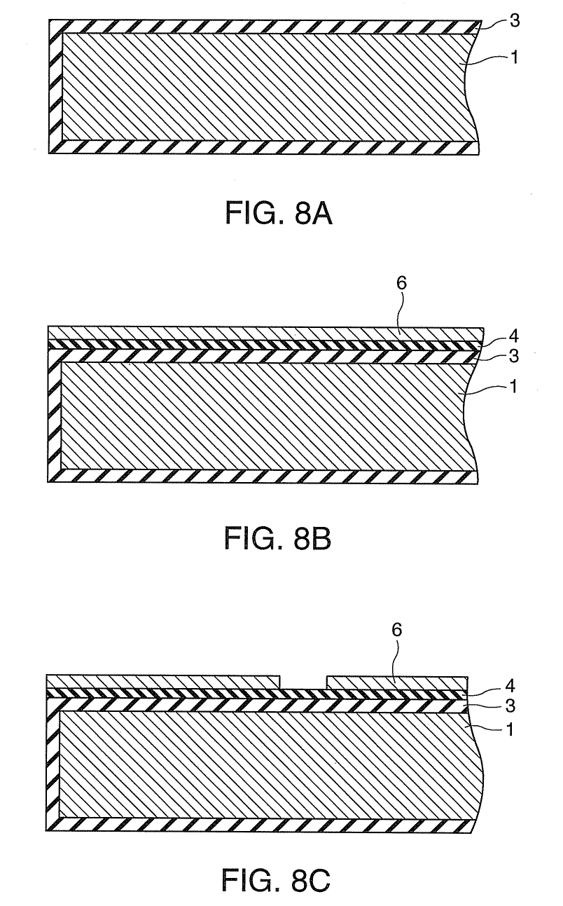

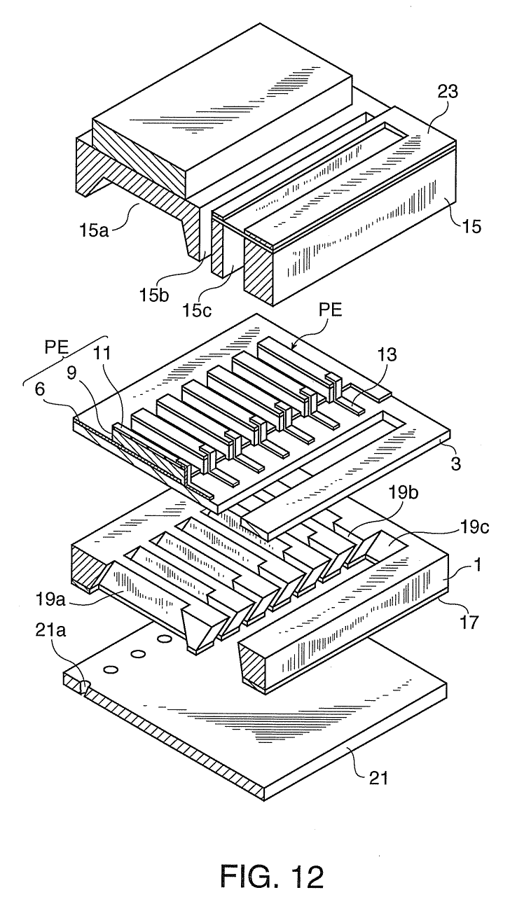

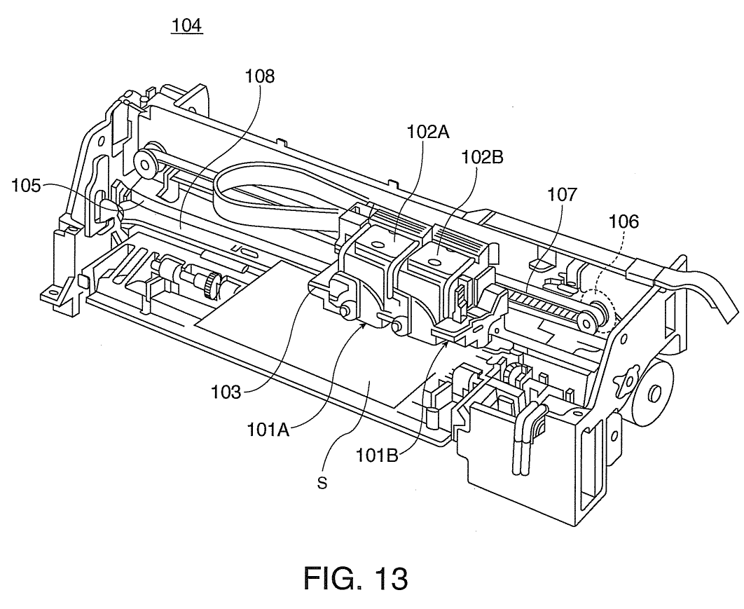

Next, a method for manufacturing a piezoelectric element that uses the above-described PZTN film is described. FIGS. 8A-11B are cross-sectional views showing steps of a method for manufacturing an ink jet recording head (liquid jet head) having the piezoelectric element in accordance with the present embodiment. FIG. 12 is an exploded perspective view of the ink jet recording head. FIG. 13 is a schematic perspective view in part of an ink jet printer (a liquid jet apparatus).

With reference to FIG. 8A-FIG. 13, the method for manufacturing piezoelectric elements and the like, and their structures shall be described.

First, as described above in the “Method for Forming PZTN Film” section, an elastic film (vibration plate) 3 is formed on a substrate 1. More specifically, as shown in FIG. 8A, a substrate 1, such as, for example, a silicon (Si) substrate is prepared, and a silicon oxide film as an elastic film (vibration plate) 3 is formed on the surface of the silicon substrate. The silicon oxide film may be formed by, for example, thermal oxidation to a film thickness of about 400 nm.

Then, as shown in FIG. 8B, a dielectric film 4 composed of titanium oxide is formed on the elastic film 3. More specifically, a titanium (Ti) film is formed on the elastic film 3 by, for example, a DC sputter method to a film thickness of about 20 nm, and the film is heat-treated, for example, at 600° C. for 30 minutes, thereby forming a dielectric film 4 composed of titanium oxide having a film thickness of about 40 nm.

Next, a lower electrode film 6 composed of a conductive film, such as, for example, a platinum (Pt) film or the like is formed on the dielectric film 4. The Pt film may be deposited by, for example, a DC sputter method to a thickness of about 150 nm. Then, the lower electrode film 6 is patterned (see FIG. 8C).

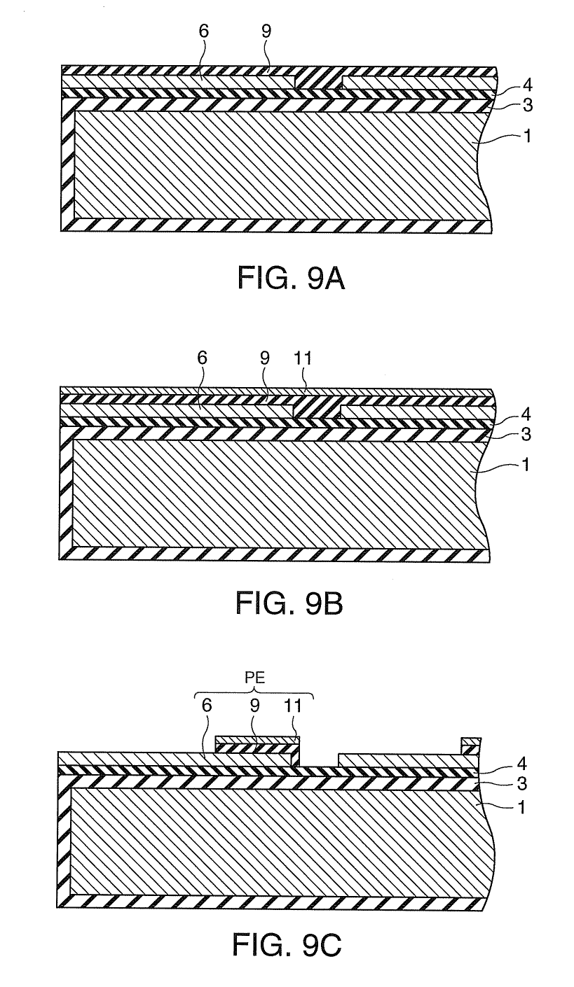

Next, as shown in FIG. 9A, a PZTN film 9 (9a-9d in FIG. 2) as described above is formed on the lower electrode film 6 as a piezoelectric film (a piezoelectric body, a piezoelectric layer). More specifically, the source material solution described above is coated on the substrate by an appropriate coating method, such as, a spin coat method, and then the film is heat treated (for drying, cleaning and sintering), thereby forming a first PZTN film 9a. Then, the steps of coating to sintering for the first round described above are repeated three times, thereby forming second-fourth PZTN films (9b, 9c and 9d), and finally, the laminated films are heat-treated at 750° C. for ten minutes by using a lamp anneal furnace, thereby forming a PZTN film 9 having a film thickness of about 700 nm.

For example, when a PZTN film having a film thickness of about 200 nm or greater is formed, the obtained PZTN film would have a higher crystallinity if the film formation and crystallization are conducted in divided multiple steps, compared to forming the film in a single step and crystallizing the same. Furthermore, by adjusting the source material solution in a manner described above, the orientation of the PZTN film is improved. In particular, in the film formation of PZTN films in the second and later rounds, which are conducted after completing crystallization in the first round, crystal orientations of the films would likely deviate from one another. However, by adjusting the source material solution described above, each of the PZTN films (9b, 9c and 9d) in the second and later rounds would be preferentially oriented to the orientation of a lower layer ((111) in this case), and thus have a good crystal orientation. Also, in the film formation of the PZTN film in the first layer, Pb in excess can be suppressed as a result of the adjustment of the source material solution, such that precipitation of Pb compounds (PbO, for example) or the like at the first layer surface can be suppressed. Therefore the crystal orientation of the second and later layers formed on the first layer can be prevented from becoming disordered, and the crystal orientation of the PZTN film 9 (9a-9d) as a whole can be improved.

Then, as shown in FIG. 9B, a conductive film (11), such as, for example, an iridium (Ir) film is deposited in about 50 nm on the PZTN film 9 by a sputter method. It is noted that, besides Ir, Pt or the like may be used. Then, as shown in FIG. 9C, the conductive film is patterned in a desired shape, thereby forming an upper electrode film (upper electrode) 11. At this time, the PZTN film 9 below the conductive film is also patterned at the same time. As a result, a piezoelectric element PE having a laminate of the lower electrode film 6, the PZTN film (piezoelectric film) 9 and the upper electrode film 11 is formed.

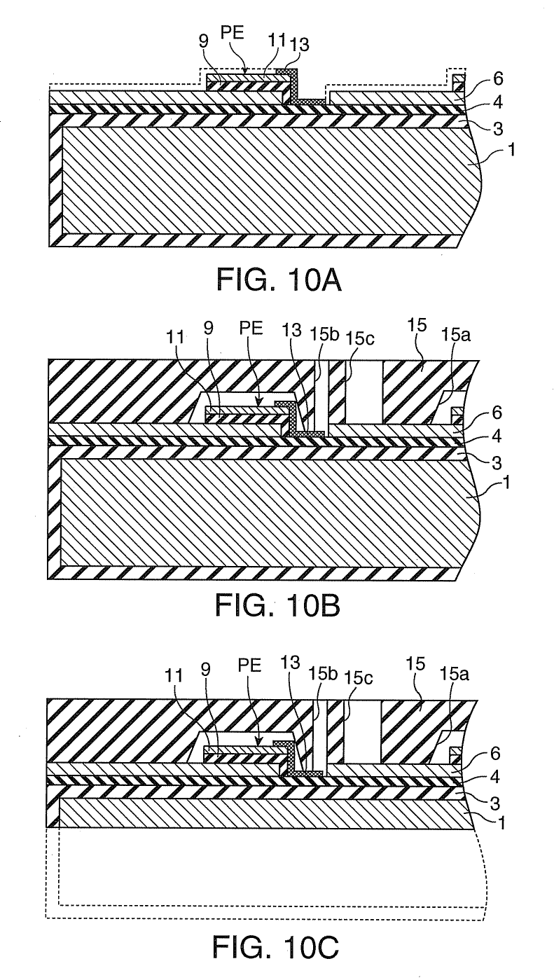

Then, as shown in FIG. 10A, a conductive film, such as, for example, a gold (Au) film is deposited on the piezoelectric element PE (on the upper electrode film 11) by a sputter method, and then patterned in a desired shape, thereby forming a lead electrode 13.

Then, as shown in FIG. 10B, a protective substrate 15 is mounted on and bonded to the piezoelectric element PE (on the substrate 1). The protective substrate 15 has a recessed section 16a in a portion corresponding to the piezoelectric element PE, and also has opening sections 15b and 15c.

Then, as shown in FIG. 10C, the back surface of the substrate 1 (the surface on the opposite side of the surface thereof where the piezoelectric element PE is formed) is polished, and further etched by wet etching, thereby reducing the film thickness of the substrate 1.

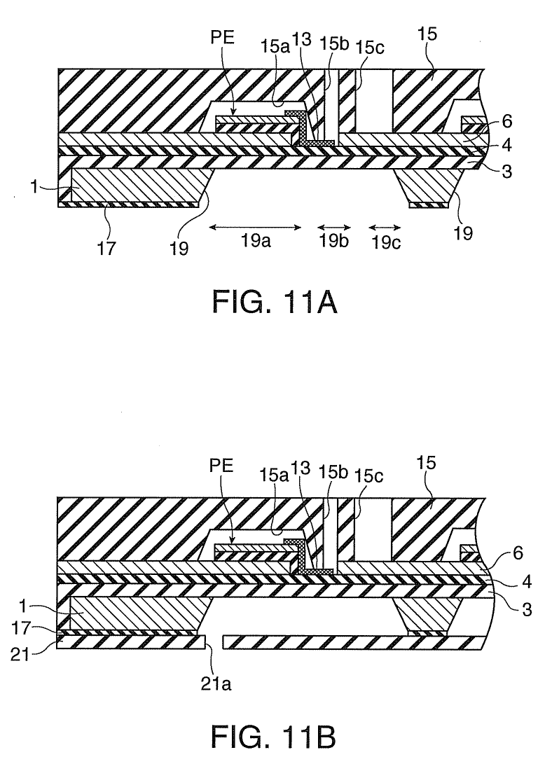

Then, as shown in FIG. 11A, as a mask film 17, for example, a silicon nitride film is deposited on the back surface of the substrate 1, and is patterned in a desired shape. Then, the substrate 1 is anisotropically etched, using the mask film 17 as a mask, thereby forming an opening section 19 in the substrate 1. The opening section 19 may be formed from opening regions 19a, 19b and 19c. Then, an outer circumferential area of the substrate 1 and the protective substrate 15 is removed and reshaped by dicing or the like.

Next, as shown in FIG. 11B, a nozzle plate 21 having a nozzle aperture (nozzle opening) 21a at a position corresponding to the opening region 19a is bonded to the back surface of the substrate 1. Also, a compliance substrate 23 to be described below is bonded to the upper portion of the protective substrate 15, and appropriately divided (scribed). By the steps described above, an ink jet recording head having a plurality of piezoelectric elements PE is substantially completed.

FIG. 12 is an exploded perspective view of an ink jet recording head, and sections thereof corresponding to those shown in FIGS. 8A-11B shall be appended with the same reference numbers.

As shown in the figure, each of the opening regions 19a located below each of the piezoelectric elements PE defines a pressure generation chamber. When an elastic film 3 is driven by the piezoelectric element PE and displaced, ink is ejected from a nozzle aperture 21a. In this embodiment, the piezoelectric element PE and the elastic film 3 combined are referred to as an actuator device. It is noted that FIG. 12 merely shows an example of the structure of an ink jet recording head, and it is obvious that many appropriate changes can be made to the structure thereof, such as, the shape of each of the piezoelectric elements PE, their arrangement direction, and the like.

FIG. 13 is a schematic perspective view in part of an ink jet printer apparatus (a liquid jet apparatus) 104. As shown in the figure, the ink jet recording heads described above are assembled in jet head units 101A and 101B. Also, cartridges 102A and 102B composing ink supply devices are detachably mounted on the jet head units 101A and 101B, respectively.

Also, the jet head units 101A and 101b per se are mounted on a carriage 103, thereby being mounted on an apparatus main body 104. The carriage 103 is moveably disposed with respect to the axial direction of a carriage shaft 105.

The driving force of a driving motor 106 is transmitted to the carriage 103 through a timing belt 107, whereby the jet head unites 101A and 101B move along the carriage shaft 105. Also, the apparatus 104 is provided with a platen 108 along the carriage shaft 105, such that a recording sheet (for example, a sheet of paper) S is transferred onto the platen 108. Ink is discharged from the jet head units 101A and 101B and printed on the recording sheet S.

It is noted that, in the embodiment described above, the ink jet recording head is described as an example. However, the invention is widely applicable to liquid jet heads, and can be used for, for example, a color material ejection head that is used for manufacturing color filters for liquid crystal displays, a liquid ejection head that is used for ejecting liquid electrode material for organic EL displays, EFDs (field emission displays) and the like, and a bioorganic material jet head used for manufacturing bio-chips.

It is noted that, in the embodiment described above, the ink jet recording head having piezoelectric elements is described as an example. However, the piezoelectric elements in accordance with the embodiment are widely applicable to ultrasonic devices such as ultrasonic oscillators, pressure sensors and the like, without being limited to those used in ink jet recording heads.

What is claimed is:

1. An oxide source material solution for forming an oxide film having a composition expressed by PbᵤZrₓTi_{1-x-y}M_{y}O₃, wherein a composition of metal element constituents in the oxide source material solution is expressed by [Pb]:([Zr]+[Ti]+[M])=v:1, and a difference (v−u) in composition ratio of Pb between the oxide source material solution and the oxide film is 0.01 or less.

2. An oxide source material solution according to claim 1, wherein the value v is 0.95 or higher but 1.15 or lower.

3. An oxide source material solution according to claim 1, wherein the element M is one of or both of Ta and Nb.

4. An oxide source material solution according to claim 1, wherein the value y is in the range of 0.05≦y<0.2.

5. An oxide source material solution according to claim 1 including 0.05 mol or less of Si or Ge as an additive for 1 mol of PbᵤZrₓTi_{1-x-y}M_{y}O₃.

6. An oxide film formed by sintering the oxide source material solution recited in claim 1.

7. An oxide film according to claim 6, wherein PbᵤZrₓTi_{1-x-y}M_{y}O₃ has an ABO₃ type perovskite structure.

8. A piezoelectric element comprising the oxide film recited in claim 6 as a piezoelectric film.

9. A method for forming an oxide film, comprising the steps of:
preparing a source material solution for forming an oxide film having a composition expressed by PbᵤZrₓTi_{1-x-y}M_{y}O₃, wherein a composition of metal element constituents in the source material solution is expressed by [Pb]:([Zr]+[Ti]+[M])=v:1;
adjusting v such that a difference (v−u) in composition ratio of Pb between the material solution and the oxide film is 0.01 or less; and
coating and then sintering the source material solution to form the oxide film.

10. A method for forming an oxide film according to claim 9, wherein the value v is 0.95 or higher but 1.15 or lower.

11. A method for forming an oxide film according to claim 9, wherein the element M is one of or both of Ta and Nb.

12. A method for forming an oxide film according to claim 9, wherein the value y is in the range of 0.05≦y<0.2.

13. A method for forming an oxide film according to claim 9, wherein the steps of coating and sintering are repeated a plurality of times.

14. A method for manufacturing a piezoelectric element, comprising the method for forming an oxide film recited in claim 9 as a method for forming a piezoelectric film.
